(19) United States
(12) Patent Application Publication
(10) Pub. No.: US 2013/0126806 A1
(43) Pub. Date: May 23, 2013

(54) HAND LIFT TRUCK

(71) Applicant: Henri Peter Maria Van Seumeren, Rossum (NL)

(72) Inventor: Henri Peter Maria Van Seumeren, Rossum (NL)

(73) Assignee: RAVAS EUROPE B.V., Zaltbommel (NL)

(21) Appl. No.: 13/641,405

(22) PCT Filed: Apr. 13, 2011
(86) PCT No.: PCT/NL2011/050247

§ 371 Date: Jan. 15, 2013

(30) Foreign Application Priority Data
Apr. 16, 2010 (NL) 2004570

(51) Int. Cl. B62B 3/06; G01G 19/12; G01G 19/08

(52) U.S. Cl. CPC B62B 3/0606; G01G 19/083; G01G 19/12
USPC 254/2 R

(57) ABSTRACT

A hand lift truck comprises a rolling frame (10 . . . 13) with at least one height-adjustable load platform (11,12) for receiving a cargo thereon. Electronic weighing means (70) are herein provided to determine a mechanical deformation of a part (13) of the frame resulting from a loading of the load platform and to determine therefrom a weight indication of an actual loading of the load platform and to display this to a user on a display panel (85). According to the invention height-indicating means which indicate the reference height are provided in the form of an electronic sensor (88) which determines a height adjustment of the load platform by electronic means and generates an electronic height signal thereof to electronic processing means. The processing means determine therefrom an actual height of the load platform and are coupled to signalling means for the purpose, at least when the reference height is reached, of generating an indication thereof the user.

The present invention relates to a hand lift truck comprising a rolling frame with at least one load platform for receiving a cargo thereon, wherein the load platform is coupled to lifting means which enable a user to vary a height of the load platform relative to a ground surface, wherein electronic weighing means are provided which are able and adapted to determine a mechanical deformation of a part of the frame resulting from a loading of the load platform and, at least at a reference height of the load platform, to generate an electronic weighing signal as a weight indication of an actual loading of the load platform, wherein the weighing means are coupled to electronic processing means with a display panel for the purpose of displaying the weight indication to a user, and wherein height-indicating means are provided which indicate the reference height.

Such a hand lift truck is for instance known from European patent publication EP 1.200.298 of applicant. Described herein is a pallet truck with a load platform in the form of a set of pallet forks extending from a so-called A-frame which is mounted displaceably relative to a movable undercarriage. Connected to a head of the A-frame is a pressure or strain-sensitive sensor which determines a mechanical deformation of that part of the A-frame and generates on the basis thereof an electronic weighing signal to processing means. The processing means are arranged together with a display panel in a strong shared housing placed over the sensor on the head of the pallet truck. A weight indication as derived by the processing means from the output signal of the sensor can be read therefrom.

Because the mechanical deformation of the A-frame or the head of the A-frame at a given load of the load platform will vary according to a lifting height of the load platform, it is important to pre-calibrate the weighing means precisely and herein define a reference height of the load platform at which the output signal of the sensor gives an accurate measure for an actual weight on the load platform. For a reliable weight determination the load platform has to be brought to the reference height before reading a weight indication. The reference level can be derived from a marking corresponding thereto on the frame of the lift truck.

Although this provides per se a solution for determining the reference height, such a marking is vulnerable and not always easy for a user to recognize. In addition, there is a danger with existing markings of a parallax reading if they are viewed at different viewing angles by different users. Furthermore, the marking may eventually become damaged or unrecognizable, whereby a reliable weighing function is impeded.

The present invention has among its objects to provide a hand lift truck with a weighing function in which this drawback is obviated to at least significant extent.

To achieve the stated object, a hand lift truck of the type stated in the preamble has the feature according to the invention that the height-indicating means comprise an electronic sensor which determines a height adjustment of the load platform by electronic means and generates an electronic height signal thereof to the processing means, and that the processing means are able and adapted to determine therefrom an actual height of the load platform and are coupled to signalling means for the purpose, at least when the reference height is reached, of generating at least an indication thereof to the user. The invention thus provides an electronic sensor for the purpose of establishing the reference height and determining a lifting height. The output signal thereof is generated to the processing means and signalled to the user by electronic means. A manual inspection of the reference height on the load platform itself is therefore no longer necessary, and the sensor can be arranged concealed in the frame so that it is less vulnerable. An electronic signalling moreover contributes in no inconsiderable measure toward the overall convenience of use of the device as a whole and the weighing means in particular.

A particular embodiment of the hand lift truck according to the invention has the feature that the lifting device comprises a tilting shaft to which at least one drive rod is eccentrically coupled in order to adjust the platform in the height, and that the electronic sensor comprises an electronic angle sensor coupled to the tilting shaft. A displacement of the drive rod, and thereby a displacement of the load platform, can thus be determined in accurate manner from an angular adjustment of the tilting shaft. The tilting shaft can lie concealed within a structure of the frame, as can therefore also the angle sensor, which is thereby sufficiently protected from outside influences. A position of the tilting shaft corresponding to the reference height is determined by the angle sensor and presented as electronic signal to the processing means.

A preferred embodiment of the hand lift truck according to the invention has the feature that the angle sensor comprises a gyroscopic acceleration sensor. Not only can an angular adjustment of the tilting shaft thus be measured using the electronic sensor, but also an acceleration thereof. In addition to giving an indication of an actual height of the load platform, this also provides information about the dynamic behaviour of the load platform during an adjustment thereof, such as a lifting/lowering speed, lifting/lowering direction and a distance the platform has been lifted or lowered. On the basis of these data a route analysis can be performed on the basis of an appropriate mathematical algorithm in order to indicate extreme manipulations as such and to carry out weighing corrections in general. The system will hereby be less sensitive to user influences and produce a more reliable and reproducible weighing result. A further preferred embodiment of the hand lift truck according to the invention is therefore characterized in that the processing means are loaded at least during operation with a processing protocol which incorporates a dynamic behaviour of an adjustment of the load platform in the weight determination and on the basis thereof carries out a satisfactory weighing correction or gives an error message.

In addition to a lifting height of the load platform, a position of a cargo on the load platform can also represent a factor in the output signal of the weighing means. In order to suppress this latter influence, a further preferred embodiment of the hand lift truck according to the invention has the feature that the undercarriage supports on a ground surface with at least one support wheel suspended for free rotation from an outer end of a wheel arm, which wheel arm is pivotable about a pivot axis, that the drive rod engages eccentrically on the wheel arm of the at least one support wheel relative to a pivot axis, and that the reference height corresponds to a position of the wheel arm oriented substantially about 45 degrees relative to the ground surface. Surprisingly, it has been found that in this position of the at least one support wheel the weighing means are not sensitive, or hardly so, to an actual positioning of a cargo on the load platform.

A further particular embodiment of the hand lift truck according to the invention has the feature that the sensor is able and adapted to detect a displacement relative to the reference height and generate this as electronic signal to the processing means. On the basis of a thus detected displacement relative to the reference height, instructions can be given to the user to lower or lift the load platform in order to thus reach the reference height more directly.

Individual signalling means can be provided per se for indicating the reference height, although a preferred embodiment of the hand lift truck has the feature according to the invention that the display panel comprises the signalling means. Both the weight indication and a correct weighing height of the load platform can thus be read on the same display panel.

The invention is particularly suitable for a hand lift truck, the load platform of which comprises a set of pallet forks, and will be further elucidated hereinbelow on the basis of a relevant exemplary embodiment, with reference to an accompanying drawing. In the drawing:

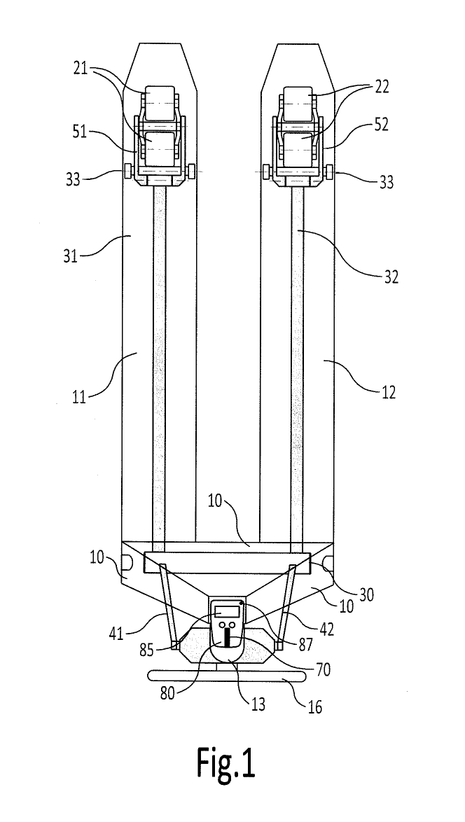

FIG. 1 shows a top view of an exemplary embodiment of a hand pallet truck according to the invention;

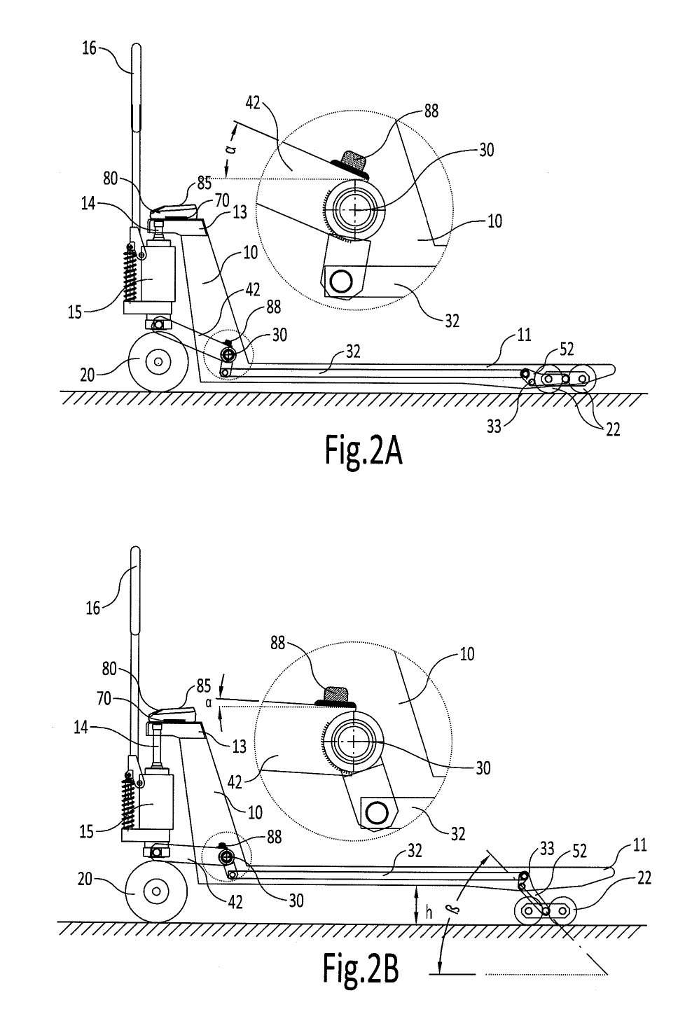

FIG. 2A shows a side view of the hand pallet truck of FIG. 1 in a first, lowered position; and

FIG. 2B shows a side view of the hand pallet truck of FIG. 1 in a second position, lifted to a reference height.

The figures are otherwise substantially schematic and not drawn to scale. Some dimensions and components in particular may be shown exaggerated to a greater or lesser extent for the sake of clarity. Corresponding parts are designated as far as possible in the figures with the same reference numerals.

The hand lift truck as shown in FIG. 1 comprises a load platform in the form of a set of pallet forks 11, 12 and is therefore generally referred to as a pallet truck or hand pallet truck. Pallet forks 11, 12 extend from a so-called A-frame 10, a left-hand and right-hand side of which meet in a shared head 13 and are mutually connected. All parts 11 . . . 13 are manufactured from robust preserved or durable steel and combined to form a unified whole by means of welding.

Head 13 is arranged, see also FIGS. 2A and 2B, on an output drive rod 14 of a hydraulic pump 15 which is operated manually by means of a control arm 16. Control arm 16 also serves for manual displacement and manoeuvring of the pallet truck. On an underside the A-frame 10 is connected to this part of the frame via a set of lifting arms 41, 42, which engage pivotally on a tilting shaft 30 in the A-frame. The height of the A-frame can thus be freely varied with pump 15, wherein tilting shaft 30 will provide a rotation. Drive rods 31, 32 which engage eccentrically on tilting shaft 30 are provided in the pallet forks. At their opposite outer end drive rods 31, 32 engage eccentrically on a wheel arm 51, 52, which is mounted for pivoting about a pivot axis 33 and carries at an outer end a set of freely rotatable support wheels 21, 22. Situated centrally under pump 15 is a third support wheel or support wheel set 20, whereby the pallet truck will always support in stable manner on a ground surface.

If A-frame 10 is manipulated with the pump, the rotation of tilting shaft 30 will thus result in a forward movement of drive rods 31, 32, whereby wheel arms 51, 52 are driven from their initial, almost horizontal position, see FIG. 2A, to a more upright position, see FIG. 2B, until the wheel arms eventually take on a substantially vertical position. Present in the control arm is a handle (not further shown) with which a valve of pump 15 can be opened so that pump 15 loses its pressure and the whole drops back to the starting position of FIG. 2A. The height of the load platform formed by pallet forks 11, 12 can thus be manually varied as desired.

To be able to determine a weight of a lifted cargo during operation the shown pallet truck is provided with weighing means. In this embodiment these weighing means comprise an electronic pressure or strain-sensitive sensor, usually referred to as strain gauge 70, which is arranged on head 13 of the A-frame and which is able and adapted to determine a mechanical deformation in this part of the frame and generate this as electronic signal. The strain gauge is coupled to electronic processing means which are arranged together with a suitable electrical power supply in a shared housing 80. Housing 80 is placed here over strain gauge 70 so as to thus protect and conceal the strain gauge from view. Situated on a visible side is an alphanumeric or graphic display panel 85, in this case a TFT LCD display, on which can be read a weight indication which has been derived from the output signal of the strain gauge by the processing means on the basis of a mathematical algorithm loaded therein.

Because a deformation of A-frame 10 or other part of the frame under the influence of a loading of the load platform will generally depend on the given lifting height, the weighing means are pre-calibrated to a determined, fixed reference height. The mathematical algorithm is also based hereon. A reliable weight indication, at least the most precise weight indication, is obtained particularly at this reference height. This entails in practice the load platform first having to be brought to this reference height before a weight indication is read or can at least be presumed correct.

For the purpose of indicating the reference height the pallet truck of this embodiment has electronic height-indicating means in the form of an electronic sensor which determines a height adjustment of the load platform by electronic means and generates an electronic output signal thereof to the processing means. The means for processing this height signal can form part of one and the same integrated electronic circuit which also provides for the weight determination, or can be provided separately. All processing means are however preferably arranged together in the same unit 80 and provided with an electrical power supply.

In this embodiment the electronic sensor comprises an electronic angle sensor 88 coupled to tilting shaft 30. The sensor in this embodiment is more particularly a gyroscopic acceleration sensor, also referred to in short as G-sensor, which, in addition to an angular adjustment, moreover determines an (angular) acceleration. The processing means can at all times determine an actual height h of the load platform from the determined angular adjustment, while the determined acceleration gives an indication of the dynamic with which the load platform has been adjusted and which can be taken into account in the mathematical algorithm for a possible correction or error message of the weight indication. G-sensor 88 is coupled to signalling means to generate to the user an indication of when the reference height, see FIG. 2B, is reached. This indication can be read graphically from the display panel and, if desired, can moreover be supported with a clearly audible bleep from a transducer 87 provided for this purpose in unit 80.

It is found in practice that it is not only the lifting height of the load platform which influences the weight determination by the weighing means, but also the position of the cargo on the load platform. Surprisingly, it has been found that this latter influence is not present, or is at least minimal, in the position shown in FIG. 2B, wherein the wheel arms form an angle β with the horizontal of about 45 degrees. In this situation the placing of the cargo on the load platform is therefore not a significant factor, or hardly so, in the weight determination. In view of this, in this exemplary embodiment this position has been used as reference height.

Although the invention has been further elucidated above with reference to only a single exemplary embodiment, it will be apparent that the invention is by no means limited thereto. On the contrary, many variations and embodiments are still possible within the scope of the invention for a person with ordinary skill in the art. Other types of sensor are thus suitable within the scope of the invention as weight sensor and as height detector, and the sensors can be arranged at different positions within the frame of the lift truck. A pressure or strain-sensitive sensor can in particular be mounted on, in or over every part of the frame susceptible to a mechanical deformation as a result of a loading of the load platform, from which a measure of this loading can be derived. The height sensor can also comprise, in addition to an angle sensor, an optical or ultrasonic sensor between opposite parts in the frame.

1. Hand lift truck comprising a rolling frame with at least one load platform for receiving a cargo thereon, wherein the load platform is coupled to lifting means which enable a user to vary a height of the load platform relative to a ground surface, wherein electronic weighing means are provided which are able and adapted to determine a mechanical deformation of a part of the frame resulting from a loading of the load platform and, at least at a reference height of the load platform, to generate an electronic weighing signal as a weight indication of an actual loading of the load platform, wherein the weighing means are coupled to electronic processing means with a display panel for the purpose of displaying the weight indication to a user, and wherein height-indicating means are provided which indicate the reference height, characterized in that the height-indicating means comprise an electronic sensor which determines a height adjustment of the load platform by electronic means and generates an electronic height signal thereof to the processing means, and that the processing means are able and adapted to determine therefrom an actual height of the load platform and are coupled to signalling means for the purpose, at least when the reference height is reached, of generating at least an indication thereof to the user.

2. Hand lift truck as claimed in claim 1, characterized in that the lifting device comprises a tilting shaft to which at least one drive rod is eccentrically coupled in order to adjust the platform in the height, and that the electronic sensor comprises an electronic angle sensor coupled to the tilting shaft.

3. Hand lift truck as claimed in claim 2, characterized in that the undercarriage supports on a ground surface with at least one support wheel suspended for free rotation from an outer end of a wheel arm, which wheel arm is pivotable about a pivot axis, that the drive rod engages eccentrically on the wheel arm of the at least one support wheel relative to a pivot axis, and that the reference height corresponds to a position of the wheel arm oriented substantially about 45 degrees relative to the ground surface.

4. Hand lift truck as claimed in claim 1, characterized in that the electronic sensor comprises a gyroscopic acceleration sensor.

5. Hand lift truck as claimed in claim 4, characterized in that the processing means are loaded at least during operation with a processing protocol which incorporates a dynamic behaviour of an adjustment of the load platform in the weight determination and on the basis thereof carries out a satisfactory weighing correction or gives an error message.

6. Hand lift truck as claimed in claim 1, characterized in that the electronic sensor is able and adapted to detect a displacement relative to the reference height and generate this as electronic signal to the processing means.

7. Hand lift truck as claimed in claim 1, characterized in that the display panel comprises the signalling means.

8. Hand lift truck as claimed in claim 1, characterized in that the load platform comprises a set of pallet forks.

9. Hand lift truck as claimed in claim 2, characterized in that the electronic sensor comprises a gyroscopic acceleration sensor.

10. Hand lift truck as claimed in claim 3, characterized in that the electronic sensor comprises a gyroscopic acceleration sensor.

11. Hand lift truck as claimed in claim 2, characterized in that the electronic sensor is able and adapted to detect a displacement relative to the reference height and generate this as electronic signal to the processing means.

12. Hand lift truck as claimed in claim 3, characterized in that the electronic sensor is able and adapted to detect a displacement relative to the reference height and generate this as electronic signal to the processing means.

13. Hand lift truck as claimed in claim 4, characterized in that the electronic sensor is able and adapted to detect a displacement relative to the reference height and generate this as electronic signal to the processing means.

14. Hand lift truck as claimed in claim 5, characterized in that the electronic sensor is able and adapted to detect a displacement relative to the reference height and generate this as electronic signal to the processing means.

15. Hand lift truck as claimed in claim 2, characterized in that the display panel comprises the signalling means.

16. Hand lift truck as claimed in claim 3, characterized in that the display panel comprises the signalling means.

17. Hand lift truck as claimed in claim 4, characterized in that the display panel comprises the signalling means.

18. Hand lift truck as claimed in claim 5, characterized in that the display panel comprises the signalling means.

19. Hand lift truck as claimed in claim 6, characterized in that the display panel comprises the signalling means.

20. Hand lift truck as claimed in claim 2, characterized in that the load platform comprises a set of pallet forks.
